(19) United States
(12) Patent Application Publication
(10) Pub. No.: US 2026/0274207 A1
(43) Pub. Date: Sep. 17, 2026

(54) VEHICLE CONTROL APPARATUS AND METHOD THEREOF

(71) Applicants: Hyundai Motor Company, Seoul (KR); Kia Corporation, Seoul (KR)

(72) Inventors: Hui Won SHIN, Hwaseong-Si (KR); Seul Ki JEON, Hwaseong-Si (KR); Eung Hwan KIM, Hwaseong-Si (KR)

(21) Appl. No.: 19/311,408

(22) Filed: Aug. 27, 2025

(30) Foreign Application Priority Data
Mar. 13, 2025 (KR) 10-2025-0032850

(51) Int. Cl. B60R 25/30; B60R 25/10; B60R 25/31; B60R 25/32

(52) U.S. Cl. CPC B60R 25/305; B60R 25/31; B60R 2025/1016; B60R 25/32

(57) ABSTRACT

An apparatus for a vehicle may comprise a processor and a memory storing at least one instruction that, when executed by the processor communicating with the memory, is configured to cause the apparatus to activate at least one sensor of a plurality of sensors of the vehicle, determine, based on the sensing data of the at least one activated sensor, that a warning condition associated with the vehicle is satisfied, generate image data associated with the warning condition and transmit, to a node, the image data in real time, wherein the image data corresponds to an interior image of the vehicle, adjust, based on a detected external environment of the vehicle, at least one configurable parameter associated with a warning signal, and output the warning signal.

### CROSS-REFERENCE TO RELATED APPLICATION

This application claims the benefit of priority to Korean Patent Application No. 10-2025-0032850, filed in the Korean Intellectual Property Office on Mar. 13, 2025, the entire contents of which are incorporated herein by reference.

### TECHNICAL FIELD

The present disclosure relates to a vehicle control apparatus and a method thereof, and more particularly, relates to technologies for performing occurrence of a warning with regard to situations inside and outside a vehicle.

### BACKGROUND

The matters described in this Background section are only for enhancement of understanding of the background of the disclosure, and should not be taken as acknowledgment that they correspond to prior art already known to those skilled in the art.

An intelligent transportation system (ITS) is an integrated traffic system for optimizing an interaction between a traffic infrastructure, a vehicle, a road, and a user using advanced information and communication technology (ICT) to improve safety, efficiency, and convenience. For example, services for a smart city and a smart car may be further realized based on third generation (3G), fourth generation (4G), and fifth generation (5G) communication technologies, as well as an Internet of things (IoT)-related technologies. High-speed communication, low latency, and bulk data transfer may be supported using 5G-Adv, 6G, and next-generation communication technologies. Additionally, features such as IoT security, edge computing/network slicing, energy efficiency, low power wide area (LPWA) communication, and the like may support communication between a vehicle and an external entity, such as another vehicle or an infrastructure.

To this end, the vehicle may include a central communication unit (CCU) for exchanging or sharing communication information with the outside. The vehicle may be configured to more efficiently predict a collision accident and a road situation by transmitting and receiving mutual driving information in real time via a communication control device. As an example, vehicle to everything (V2X) is a communication scheme for exchanging or sharing information, such as a traffic situation, while communicating with a road infrastructure and another vehicle while driving, and is configured to enable all elements of the road (e.g., a vehicle and a vehicle, a vehicle and an infrastructure, a vehicle and a pedestrian, a vehicle and a network, and the like) to transmit and receive information in real time.

Furthermore, a navigation technology continues to evolve via integration of various technologies including autonomous driving, and is advancing toward a synthetic driving support system beyond simple route guidance. Such a navigation technology increases convenience and safety of a vehicle at the same time and is becoming a key element of smart mobility. In addition, a rear occupant alert (ROA) may be implemented as a key safety feature in a vehicle, providing sophisticated detection and response functions together with advanced sensor technologies. Furthermore, the ROA may be combined with artificial intelligence (AI) and the V2X technology and to support various types of advanced services.

### SUMMARY

The present disclosure has been made to solve the above-mentioned problems.

According to the present disclosure, an apparatus for a vehicle, the apparatus may comprise a processor, and a memory storing at least one instruction that, when executed by the processor communicating with the memory, is configured to cause the apparatus to, activate at least one sensor of a plurality of sensors of the vehicle, determine, based on the sensing data of the at least one activated sensor, that a warning condition associated with the vehicle is satisfied, generate image data associated with the warning condition and transmit, to a node, the image data in real time, wherein the image data corresponds to an interior image of the vehicle, adjust, based on a detected external environment of the vehicle, at least one configurable parameter associated with a warning signal indicating the warning condition, and output, based on the warning condition being satisfied and the at least one adjusted configurable parameter, the warning signal.

The apparatus, wherein the at least one instruction, when executed by the processor communicating with the memory, is configured to cause the apparatus to determine that the warning condition is satisfied by, determining, based on the sensing data, whether a potential occupant is present in the vehicle, and, wherein the at least one sensor may comprise at least one of radio and detection ranging (RADAR), or an ultra-wideband (UWB) sensor.

The apparatus, wherein the at least one instruction, when executed by the processor communicating with the memory, is configured to cause the apparatus to detect the external environment by, determining, via at least one second sensor of the plurality of sensors and based on a determination that the potential occupant is present in the vehicle, whether an impact occurs on an exterior of the vehicle, and, wherein the at least one second sensor may comprise at least one of a built-in camera or an acceleration sensor.

The apparatus, wherein the at least one instruction, when executed by the processor communicating with the memory, is configured to cause the apparatus to, determine, via the at least one sensor and based on the image data, whether the potential occupant is an adult passenger, and process the interior image to verify the warning condition, wherein the interior image is captured by at least one third sensor of the plurality of sensors, and, wherein the at least one third sensor may comprise an in-cabin camera.

The apparatus, wherein the at least one instruction, when executed by the processor communicating with the memory, is configured to cause the apparatus to, activate a warning device to output the warning signal based on, no passenger being present in the vehicle, or, no adult passenger being present in the vehicle and the impact occurring on the exterior of the vehicle, or, control, based on the adult passenger being present in the vehicle and the impact occurring on the exterior of the vehicle, the warning device to remain deactivated such that a warning signal is suppressed.

The apparatus, wherein the at least one instruction, when executed by the processor communicating with the memory, is configured to cause the apparatus to transmit the image data by, transmitting, via a wireless communication circuit, the image data to a mobile device in real time, and, wherein the wireless communication circuit may comprise at least one of a wireless-fidelity (Wi-Fi) transceiver or a mobile communication transceiver.

The apparatus, wherein the at least one instruction, when executed by the processor communicating with the memory, is configured to cause the apparatus to, record information about the warning condition.

The apparatus, wherein the at least one instruction, when executed by the processor communicating with the memory, is configured to cause the apparatus to, identify, via the at least one sensor, a plurality of types of sensing data associated with an interior and an exterior of the vehicle, and determine, based on the plurality of types of sensing data, whether the warning condition is satisfied, wherein the at least one sensor may comprise a vehicle key proximity sensor, a Bluetooth low energy (BLE) circuit, a near field communication (NFC) circuit, or a ultra-wideband (UWB) communication circuit, and determine, via the at least one sensor, whether a driver of the vehicle is present within a threshold distance from the vehicle.

The apparatus, wherein the at least one instruction, when executed by the processor communicating with the memory, is configured to cause the apparatus to, adjust, based on the driver being present within the threshold distance from the vehicle, operation of a warning device to output a warning signal having a reduced intensity level.

The apparatus, wherein the at least one instruction, when executed by the processor communicating with the memory, is configured to cause the apparatus to, based on the plurality of types of sensing data and a position of a person within a threshold distance from the vehicle, set a visual warning, and adjust a warning signal setting based on second sensing data obtained from at least one sensor of the plurality of sensors, wherein the second sensing data indicates a state associated with the vehicle, and, wherein the warning device may comprise at least one of an in/out-cabin display, a light-emitting diode (LED) warning lamp, or a speaker.

The apparatus, wherein the at least one instruction, when executed by the processor communicating with the memory, is configured to cause the apparatus to, determine, via at least one light sensor of the plurality of sensors, cabin illuminance inside the vehicle and exterior illuminance outside the vehicle, and control, based on the cabin illuminance and the exterior illuminance, lights inside and outside the vehicle, wherein the at least one light sensor may comprise at least one of an in-cabin light sensor or an out-cabin light sensor, wherein the apparatus further may comprise at least one of a vehicle display or an LED warning lamp for outputting a visual warning, and, wherein the vehicle display may comprise at least one of a dashboard or a head-up display.

According to the present disclosure, a method performed by an apparatus for a vehicle, the apparatus may comprise activating at least one sensor of a plurality of sensors of the vehicle, determining, based on sensing data of the activated at least one sensor, that a warning condition associated with the vehicle is satisfied, generating image data associated with the warning condition, transmitting, to a node, the image data in real time, wherein the image data corresponds to an interior image of the vehicle, adjusting, based on a detected external environment of the vehicle, at least one configurable parameter associated with a warning signal indicating the warning condition, and outputting, based on the warning condition being satisfied and the at least one adjusted configurable parameter, the warning signal.

The method may further comprise determining, based on the sensing data, whether a potential occupant is present in the vehicle, wherein the at least one sensor may comprise at least one of radio and detection ranging (RADAR) or an ultra-wideband (UWB) sensor.

The method may further comprise determining, via at least one second sensor of the plurality of sensors and based on a determination that the potential occupant is present in the vehicle, whether an impact occurs on an exterior of the vehicle, wherein the at least one second sensor may comprise at least one of a built-in camera or an acceleration sensor.

The method may further comprise determining, via the at least one sensor and based on the image data, whether the potential occupant is an adult passenger, processing the interior image to verify the warning condition, wherein the interior image is captured by at least one third sensor of the plurality of sensors, and determining, based on the processed image, that the warning condition is verified.

The method may further comprise generating the warning signal, based on, no passenger being present in the vehicle, or, no adult passenger being detected and the impact occurring on the exterior of the vehicle, or, suppressing the generation of the warning signal, based on the adult passenger being detected in the vehicle and the impact occurring on the exterior of the vehicle.

According to the present disclosure, a vehicle may comprise a plurality of sensors may comprise at least one first sensor configured to monitor an interior of the vehicle and at least one second sensor configured to monitor an exterior of the vehicle, a processor, and a memory storing at least one instruction that, when executed by the processor communicating with the memory, is configured to cause the vehicle to, control the at least one first sensor to monitor the interior of the vehicle, detect, based on the first sensor data associated with the interior of the vehicle, a potential occupant inside the vehicle, control the at least one second sensor to monitor the exterior of the vehicle, determine, based on the second sensor data associated with the exterior of the vehicle, an external condition of the vehicle, based on information associated with the detected potential occupant and the external condition, determine whether to generate a warning signal, adjust, based on the external condition of the vehicle, at least one of a visual or auditory form of the warning signal such that at least one of the potential occupant or the warning signal is perceivable under the external condition of the vehicle, store information associated with the warning signal, wherein the information associated with the warning signal may comprise image data and timing information, and transmit the image data in real time to a remote device.

The vehicle, wherein the at least one instruction, when executed by the processor communicating with the memory, is configured to cause the vehicle to, activate outputting of the warning signal based on, no adult passenger being detected inside the vehicle, and, an external impact being detected, and, suppress outputting of the warning signal based on an adult passenger being detected inside the vehicle and the external impact being detected.

The vehicle, wherein the at least one instruction, when executed by the processor communicating with the memory, is configured to cause the vehicle to tag the image data with a timestamp identifying when the warning signal was generated, and control, based on a detected illumination level of the vehicle, lighting of the vehicle such that the visual form of the warning signal and visual display of images associated with the image data remain visible even under illumination levels of the vehicle below a threshold.

The vehicle, wherein the at least one instruction, when executed by the processor communicating with the memory, is configured to cause the vehicle to increase, based on the detected illumination level, brightness of at least one of an interior lighting of the vehicle or an exterior lighting of the vehicle.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a configuration of a vehicle system including a vehicle control apparatus according to an example of the present disclosure;

FIG. 2 shows an example of a configuration of a vehicle communication control system according to an example of the present disclosure;

FIG. 3 shows an example of a system for performing a warning control function according to an example of the present disclosure;

FIG. 4 shows an example of a method for controlling a false warning according to an example of the present disclosure;

FIG. 5A, FIG. 5B, FIG. 5C, and FIG. 5D show an example of controlling a false warning according to an example of the present disclosure;

FIG. 6 shows an example of a method for controlling data logging, if a warning occurs, according to an example of the present disclosure;

FIG. 7A and FIG. 7B show an example of a data-logged vehicle interior image in various shapes according to an example of the present disclosure;

FIG. 8 shows an example of a method for recognizing an external situation and controlling a warning according to an example of the present disclosure;

FIG. 9A, FIG. 9B, FIG. 9C, and FIG. 9D show examples of performing a warning according to an example of the present disclosure;

FIG. 10 shows an example of a method for controlling an ambient light with regard to brightness in a vehicle according to an example of the present disclosure;

FIG. 11A, FIG. 11B, FIG. 11C, and FIG. 11D show an example of controlling an ambient light with regard to brightness in a vehicle according to an example of the present disclosure; and

FIG. 12 shows an example computing system according to an example of the present disclosure.

### DETAILED DESCRIPTION

Hereinafter, some examples of the present disclosure will be described in detail with reference to the exemplary drawings. In adding the reference numerals to the components of each drawing, it should be noted that the identical component is designated by the identical numerals even when they are displayed on other drawings. Further, in describing the example of the present disclosure, a detailed description of well-known features or functions will be ruled out in order not to unnecessarily obscure the gist of the present disclosure.

In describing components of examples of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

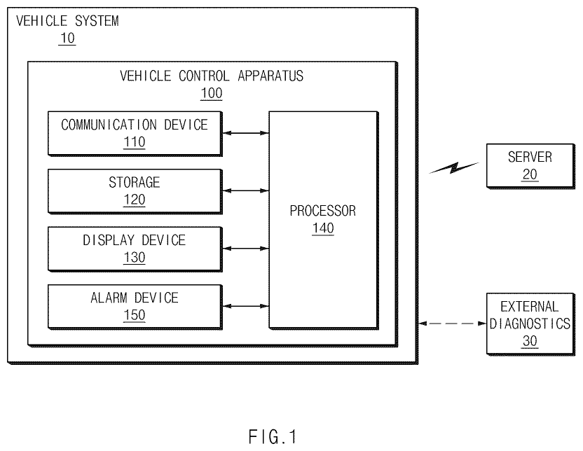

Hereinafter, examples of the present disclosure will be described in detail with reference to FIGS. 1 to 12.

FIG. 1 shows an example of a configuration of a vehicle system including a vehicle control apparatus according to an example of the present disclosure.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., feature of passenger safety monitoring, occupant detection, and alerting) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., feature of passenger safety monitoring, occupant detection, and alerting) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., feature of passenger safety monitoring, occupant detection, and alerting) described herein.

Minimum risk maneuver (MRM) operation(s) may also be controlled, for example, based on one or more features (e.g., feature of passenger safety monitoring, occupant detection, and alerting) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., feature of passenger safety monitoring, occupant detection, and alerting) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., feature of passenger safety monitoring, occupant detection, and alerting) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

A smart vehicle alert system is configured to improve safety by accurately detecting whether passengers-especially children-remain inside a parked vehicle and by responding intelligently to emergency situations. Rear occupant alert (ROA) systems may rely on radar or UWB sensors to detect movement, but they may generate false alarms by mistaking objects like metal items or water bottles for people. To reduce such errors, the smart vehicle alert system combine data from multiple sources, comprising radar, UWB sensors, interior cameras, and exterior cameras, etc., enabling more reliable decisions. For example, when a potential passenger is detected, the system cross-checks for the presence of adults using in-cabin cameras and determines whether an external impact has occurred using built-in accelerometers. If a legitimate risk is identified, it activates warning devices such as lights, sounds, or audible alerts that describe nearby individuals to prompt intervention. The system can also stream interior footage in real time to a mobile app and log images with timestamps for later review. Further, ambient light sensors may be used to automatically adjust interior lighting, ensuring that warnings and image recordings remain visible even in low-light conditions. By combining real-time analysis, data logging, adaptive warnings, and intelligent lighting, the system may enhance the overall reliability and effectiveness of in-vehicle safety alerts.

Referring to FIG. 1, a vehicle control apparatus 100 according to an example of the present disclosure may be implemented in a vehicle. In this case, the vehicle control apparatus 100 may be integrally configured with control units in the vehicle or may be implemented as a separate device to be connected with the control units of the vehicle by a separate connection means (e.g., a wired harness, a wireless module, a CAN interface, or an Ethernet bridge, etc.). As an example, the vehicle control apparatus 100 may include a shift control device for managing and controlling various sub-systems (e.g., a shift device, an engine, a brake, or a battery management system, etc.) of the vehicle in an integrated manner. Furthermore, the vehicle control apparatus 100 may include a program for supporting a navigation service and guiding a route to a destination based on a current location of the vehicle (e.g., via GPS, dead reckoning, or real-time traffic input, etc.). Furthermore, the vehicle control apparatus 100 may include an infotainment platform and system for providing an accurate route using a global positioning system (GPS) and map data and reflecting real-time traffic information to provide an optimal route (e.g., shortest distance, minimum fuel, or least congested path, etc.). The vehicle control apparatus 100 according to an example of the present disclosure may include a shift control device and an intrusion detection system to manage physical and digital elements in an integrated manner and may be integrally configured with control units for ensuring safety and performance of the vehicle or may be implemented as a separate device to be connected with the control units of the vehicle.

The vehicle control apparatus 100 according to an example of the present disclosure may include a communication device 110, storage 120, a display device 130, a processor 140, and an alarm device 150 (e.g., a speaker, a vibrating motor, or a lighting module, etc.).

The communication device 110 may be a hardware device implemented with various electronic circuits to transmit and receive a signal via a wireless or wired connection, which may perform in-vehicle communication via controller area network (CAN) communication, CAN flexible data rate (CAN-FD) communication, local interconnect network (LIN) communication, Ethernet communication, or the like according to an example of the present disclosure (e.g., over a twisted pair, optical fiber, or coaxial cable, etc.).

The communication device 110 may include various communication units, for example, a mobile communication unit, a broadcast reception unit, such as a digital multimedia broadcasting (DMB) module or a digital video broadcasting-handheld (DVB-H) module, a short range communication unit, such as a ZigBee module, a Bluetooth module, or a near field communication (NFC) module, and a wireless-fidelity (Wi-Fi) communication unit (e.g., IEEE 802.11p, 802.11ac, or 802.11ax, etc.). Herein, the CAN communication is a network system for a vehicle, which is developed to provide digital serial communication between various pieces of measurement control equipment in the vehicle. A CAN-data bus is used for data transfer and control between electronic control units (ECUs) (e.g., an engine control module, a brake controller, or an airbag deployment module, etc.).

Furthermore, the communication device 110 according to an example of the present disclosure may perform communication bidirectionally between a vehicle and a surrounding vehicle, a vehicle and a road infrastructure, and a vehicle and a pedestrian (e.g., for collision avoidance, traffic signal coordination, or crosswalk detection, etc.) The communication device 110 may continuously share and transmit and receive data with all elements including a host vehicle and a surrounding vehicle (e.g., nearby autonomous cars, roadside sensors, or pedestrian mobile devices, etc.). The communication device 110 may be configured in the form of being internally loaded into the vehicle or being in contact with a communication terminal (e.g., a telematics control unit, a smart gateway, or a vehicle-mounted modem, etc.). As a result, the communication device 110 may perform vehicle-to-vehicle communication and vehicle-to-infrastructure communication and may perform autonomous driving to a determined destination via a vehicle sensor and a driving control function provided in the vehicle (e.g., through adaptive cruise control, lane guidance, or automatic braking, etc.). Herein, the vehicle sensor may include at least one of a global positioning system (GPS) sensor, a gyro sensor, or an acceleration sensor (e.g., a MEMS accelerometer or digital gyroscope, etc.). The GPS sensor, the gyro sensor, the acceleration sensor, or the like may measure a location, motion, a pose, or the like of the vehicle and may be coupled to other sensors in the vehicle to support driving safety, autonomous driving, navigation, and vehicle tracking and management (e.g., electronic stability control or driver-assistance features, etc.) Particularly, the gyro sensor and the acceleration sensor may be coupled to light detection and ranging (LiDAR), a camera, or radio detection and ranging (RADAR) to monitor a location and a pose of the vehicle in real time. The acceleration sensor and the gyro sensor may be combined with each other to control rotation and acceleration of the vehicle (e.g., in drift detection, curve handling, or adaptive suspension control, etc.). Furthermore, the location may be tracked via the GPS sensor, the direction may be maintained using the gyro sensor, and the change in motion may be detected using the acceleration sensor to perform precise route tracking and real-time driving control for an autonomous vehicle (e.g., lane-keeping in tunnels or mapping detours in GPS-denied areas, etc.). Furthermore, an environment detection sensor for recognizing an external environment may include LiDAR for generating three-dimensional (3D) terrain data around the vehicle using laser, RADAR for measuring a vehicle distance and speed using radio waves, an ultrasonic sensor (e.g., a parking assist system, blind-spot detection, or automatic parking aid, etc.) for sensing an object in a short distance, a camera sensor for sensing lane keeping, recognizing a road sign, and sensing a pedestrian, and the like. Various sensor fusion technologies therefor may be applied (e.g., Kalman filtering, deep learning-based fusion, or rule-based integration, etc.).

The communication device 110 may support a WAVE communication technology for a V2X communication function or may support a next-generation communication technology including 3GPP-based LTE/NR/5G-Adv and 6G (e.g., for low-latency messaging, map sharing, or over-the-air updates, etc.). For example, if supporting a new radio (NR) access technology of a 5G system, the communication device 110 may support enhanced mobile broadband (eMBB), massive machine type communications (mMTC), or ultra-reliable and low-latency communications (URLLC) (e.g., for HD video streaming, remote diagnostics, or automated emergency braking, etc.). A wireless communication module may support a high-frequency band (e.g., mmWave band) to achieve a high data transfer rate (e.g., for sensor sharing, real-time navigation, or remote control features, etc.). Various technologies applied to ensure performance in a high-frequency band by the wireless communication module may support, for example, beamforming, massive multiple-input and multiple-output (MIMO), full dimensional MIMO (FD-MIMO), an array antenna, analog beam-forming, a large scale antenna, or the like. Furthermore, as a next-generation communication technology is developed, a new type of AL/ML module or the like which is newly proposed may be used (e.g., for path prediction, anomaly detection, or dynamic signal prioritization, etc.). A wireless communication module capable of performing a signal processing task, such as channel estimation, equalization, or demapping, may be supported. Thus, service optimization and data via a more efficient network air interface, channel estimation, or the like may be applied (e.g., for seamless handover, interference reduction, or adaptive bandwidth control, etc.). As an example, according to the present disclosure, if supporting wireless access for vehicle environment (WAVE) communication, the communication device 110 may support an IEEE 802.11a wireless LAN technology for smooth V2V and V2I communication (e.g., for cooperative awareness messaging, forward-collision alerts, or infrastructure-triggered speed adjustments, etc.). Thus, the communication device 110 may use a 10 MHz channel bandwidth in a 5.9 GHz band, may support a maximum data rate of 27 Mbps, may support CSMA/CA in a wireless channel access scheme, and may support a physical layer based on IEEE 802.11p and an upper layer protocol stack using IEEE 1609.x standard (e.g., 1609.2 for security, 1609.3 for networking, or 1609.4 for multi-channel operation, etc.).

Furthermore, if supporting the 3GPP system, the communication device 110 according to an example of the present disclosure may support LTE eV2X, 5G/5G-Adv, and 6G NR V2X communication technologies, based on LTE V2X (Rel. 14). (e.g., for cooperative driving, blind spot warning, or intersection management, etc.). Roughly, V2X communication includes vehicle-to-vehicle (V2V) referring to LTE/NR-based communication between vehicles, vehicle-to-pedestrian (V2P) referring to LTE/NR-based communication between terminals carried by a vehicle and a person, and vehicle-to-infrastructure/network (V2I/N) referring to LTE/NR-based communication between a vehicle and a roadside unit/network and has a characteristic in which network scalability is improved in V2I communication using OFDMA wireless access (e.g., for traffic signal priority, dynamic rerouting, or emergency vehicle notification, etc.). In addition, 5G NR, 5G-Adv, 6G, and next-generation communication systems may support a more improved V2X service, such as sensor data sharing of an autonomous vehicle for ultra-low latency and high reliability communication and a high-definition map update, which may include considering coexistence and interoperability with existing LTE V2X (e.g., through dual-mode modules or protocol adapters, etc.). Thus, the communication device 110 may improve reliability, latency, a throughput, or the like of vehicle communication to support a safer and more efficient traffic system (e.g., by enabling platooning, congestion-aware routing, or predictive braking coordination, etc.).

Furthermore, there is no limit to a multi-access technique of a wireless communication system to which the present disclosure is applied. For example, various multi-access techniques, such as code division multiple access (CDMA), time division multiple access (TDMA), frequency division multiple access (FDMA), orthogonal frequency division multiple access (OFDMA), single carrier-FDMA (SC-FDMA), OFDM-FDMA, OFDM-TDMA, and OFDM-CDMA, may be used (e.g., depending on network congestion, mobility state, or interference conditions, etc.). Furthermore, a time division duplex (TDD) scheme where data is transmitted in a different time or a frequency division duplex (FDD) scheme where data is transmitted using a different frequency may be used for uplink transmission or downlink transmission (e.g., TDD for low-latency bursts, FDD for sustained high-throughput, etc.).

The storage 120 may download and store various pieces of service data for a corresponding vehicle and data for a vehicle wireless update, which are received from a server 20 via the communication device 110 (e.g., firmware updates, map files, or vehicle health reports, etc.) Thus, the storage 120 may check and store/manage/update location information of a host vehicle, road information, and road surrounding information, such as a bus stop, as well as pieces of information about a road environment via vehicle sensors provided in the vehicle and the server 20 (e.g., accident zones, weather conditions, or detour alerts, etc.). Furthermore, the storage 120 may receive and store destination information set by a user, a previously navigated route, or infrastructure information associated with the outside or traffic, which is updated in real time, or the like at a determined period or according to a set service (e.g., a scheduled data sync, on-demand navigation update, or predictive routing suggestion, etc.) Furthermore, the storage 120 may store/manage data for various input sensors for supporting autonomous driving according to the present disclosure and may store/manage data via a server for supporting road information, communication information, and the like (e.g., LIDAR maps, SVM images, or UWB tag locations, etc.). This includes that it is able to store/manage/update road and traffic information received via a communication server and sensor data input via various sensors provided inside/outside the vehicle (e.g., cabin cameras, RADAR units, external microphones, or ambient light sensors, etc.).

The storage 120 may include at least one type of storage medium, such as a flash memory type memory, a hard disk type memory, a micro type memory, a card type memory (e.g., a secure digital (SD) card or an extreme digital (XD) card, etc.), a random access memory (RAM), a static RAM (SRAM), a read-only memory (ROM), a programmable ROM (PROM), an electrically erasable PROM (EEPROM), a magnetic RAM (MRAM), a magnetic disk, and an optical disk (e.g., DVD or Blu-ray, etc.).

The display device 130 may be controlled by the processor 140 to display a screen for receiving approval for user authentication for a wireless update of the vehicle (e.g., software over-the-air updates, firmware patching, or map data refresh, etc.). The display device 130 may be implemented as a head-up display (HUD), a cluster, audio video navigation (AVN), or the like. Furthermore, the display device 130 may include at least one of a liquid crystal display (LCD), a thin film transistor-LCD (TFT-LCD), a light emitting diode (LED) display, an organic LED (OLED) display, an active matrix OLED (AMOLED) display, a flexible display, a bended display, or a three-dimensional (3D) display (e.g., autostereoscopic panel, etc.). Some thereof may be implemented as transparent displays configured as a transparent type or a semi-transparent type to see the outside (e.g., for HUDs projected on windshields or AR overlays, etc.). Furthermore, the display device 130 may be provided as a touchscreen including a touch panel to be used as an input device other than an output device (e.g., for gesture-based menu navigation, virtual keyboards, or infotainment control, etc.).

The processor 140 may be electrically connected with the communication device 110, the storage 120, the display device 130, the alarm device 150, or the like and may electrically control the respective components (e.g., initiating data transfer, rendering interfaces, or triggering alerts, etc.). The processor 140 may be an electrical circuit that executes instructions from software and may perform a variety of data processing and calculation described below (e.g., sensor fusion, AI inference, or encryption tasks, etc.). Such a processor 140 may apply a new type of AI/ML model newly proposed or may support adaptive data processing and calculation with regard to an AI/ML model implemented therein (e.g., for driver behavior prediction, object detection, or traffic forecasting, etc.).

If a screen for receiving approval from the user is displayed on the display device 130, the alarm device 150 may output a notification for approval to the user (e.g., through audio chime, LED indicator, or haptic feedback, etc.). Alternatively, the alarm device 150 may provide various pieces of information for a V2X service (e.g., a route resetting for a congestion degree, driving guidance, such as an alarm, for a congestion degree, emergency alerts, traffic safety, and the like) and pieces of infotainment information in the vehicle (e.g., incoming calls, media playback status, or navigation turn prompts, etc.).

The vehicle according to the present disclosure may include a plurality of electronic control units (ECUs), which may be connected with internal/external communication to provide an increase in safety of the user and various convenience functions (e.g., automatic seat adjustment, power window control, or anti-theft detection, etc.). The ECU may be a module for performing various electronic control functions in the vehicle. As an example, the ECU may include an engine control module (ECM) for handling engine performance optimization and control, a transmission control module (TCM) for managing a shift device, a brake module (BCM) for managing and controlling a brake system, an airbag control unit (ACU) for controlling operation and management of an airbag, a body control module (BCM) for managing and controlling a vehicle body-related function, such as door lock or an ambient light of the vehicle, and the like (e.g., seatbelt tensioners, sunroof actuators, or wiper controls, etc.).

To this end, a controller area network (CAN) data bus may support communication between ECUs in the vehicle (e.g., for sharing sensor readings, diagnostic messages, or actuator commands, etc.). As a result, ECUs may transmit and receive sensor data and commands in real time, and may control various functions of the vehicle in an integrated manner (e.g., braking, engine timing, or lighting control, etc.). Alternatively, FlexRay may be applied as a communication protocol within the vehicle. The FlexRay may support a maximum data transfer rate of 10 Mbps and may implement redundancy via two independent communication channels (e.g., for fault-tolerant brake-by-wire or steer-by-wire systems, etc.) or may increase data transfer. Furthermore, the FlexRay may apply the concept of a time slot such that all nodes on the network are able to transmit data without collision using a TDMA scheme and may share data necessary to determine autonomous driving between ECUs to support ADAS and autonomous driving (e.g., lane centering, emergency steering, or adaptive cruise control, etc.). As an example, data generated in the vehicle via the FlexRay may be transmitted to another vehicle or an infrastructure over a 3GPP-based communication network (e.g., LTE, 5G, or future 6G systems, etc.).

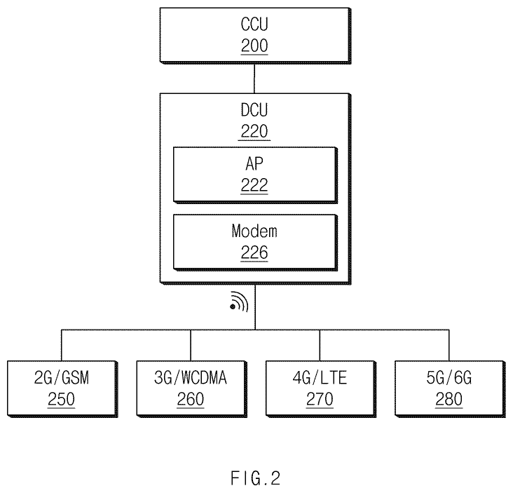

FIG. 2 shows an example of a configuration of a vehicle communication control system according to an example of the present disclosure.

Referring to FIG. 2, a central communication unit (CCU) 200 may be a communication control device of a vehicle, which may include a central control device for managing data communication between networks inside and outside the vehicle (e.g., sensor buses, infotainment networks, or external cloud links, etc.). Furthermore, the CCU 200 may include functionality for providing a connection between various ECUs and systems in the vehicle and with an external server or a cloud service (e.g., for remote diagnostics, software updates, or telematics data reporting, etc.). The CCU 200 according to an example of the present disclosure may support V2X communication (e.g., V2V data exchange and V2I data exchange), may support a connected service (e.g., real-time navigation, remote diagnosis, or an over-the-air (OTA) update), may support a data gateway (e.g., a bridge role between a protocol, such as a CAN or a LIN inside the vehicle, and LTE, 5G/5G-Adv, or 6G communication outside the vehicle), and may support security management (e.g., data encryption and intrusion detection in a vehicle communication channel such as TLS/SSL, VPNs, or digital certificate validation, etc.).

A data communication unit (DCU) 220 may be a control device for controlling and managing a specific domain (or a function area) of the vehicle, which may integrate a plurality of distributed ECUs to efficiently control each domain (e.g., a powertrain, a vehicle body, an infotainment, thermal management, or advanced driver-assistance systems (ADAS), etc.). As an example, if supporting ECU integration, the DCU 220 may reduce system complexity by integrating roles of several ECUs, thus providing an advantage of reducing the cost of operating the system (e.g., reducing wiring harnesses, power consumption, or control latency, etc.). Furthermore, if data is processed in real time, the DCU 220 may support quick and accurate data processing. As a result, the DCU 220 may reinforce both autonomous vehicle and a vehicle control function (e.g., obstacle detection, torque vectoring, or drive mode selection, etc.). If a modularization design scheme is applied, the DCU 220 may provide an advantage in which it is easy to perform maintenance because it is possible to perform independent management for each domain (e.g., replacing a faulty infotainment controller without impacting the powertrain domain, etc.). Furthermore, the DCU 220 may support high-performance calculation and optimization in a main domain (e.g., a frame and an electric system such as a chassis control system, an electric propulsion system, or a battery management system, etc.) of a vehicle via smart control. As an example, the DCU 220 may manage an electric drive system of the vehicle to optimize battery efficiency or may manage an infotainment system to improve user experience (e.g., by pre-conditioning audio preferences, navigation history, or energy-saving driving modes, etc.).

The CCU 200 according to an example of the present disclosure is able to transmit and receive data via communication with the outside in an ignition on (IGN ON) state (e.g., a state in which the electric system of the vehicle is activated, the engine is ready to start, and power is supplied to onboard electronics of the vehicle, or a state in which the ignition switch is turned on, etc.). The DCU 220 may perform main control for a vehicle domain in the IGN ON state. On the other hand, in an ignition off (IGN OFF) state (e.g., a state in which both the vehicle's electric system and engine are deactivated, the engine is turned off, and ignition switch is turned off, etc.), the CCU 200 and the DCU 220 may enter a low-power mode to operate to minimize the use of the battery and operate only a basic maintenance function (e.g., security monitoring, remote diagnostics, or scheduled wake-ups, etc.).

In an example of the present disclosure, the CCU 200 and the DCU 220 are described as separate units, but may be integrated and configured into the vehicle and may operate together with the IGN state to optimize efficiency and performance of the vehicle (e.g., reducing latency or simplifying wiring, etc.). If the vehicle completes its parking and is ignition off according to an example of the present disclosure, it enters a sleep mode state. This may control an application (AP) area 222 of the DCU 220 to operate in the sleep mode state and may control a modem area 226 to operate in an on state (e.g., for remote wake-up, emergency alerts, or push updates, etc.). Herein, the modem-on state may be a state in which the vehicle is normally registered in a network, which includes a state in which a connection setup is maintained in a next-generation communication wireless network system including GSM 250, WCDMA 260, LTE 270, and NR/5G-Adv/6G 280 depending on a surrounding network environment (e.g., urban LTE, rural 3G, or dense urban 6G coverage, etc.).

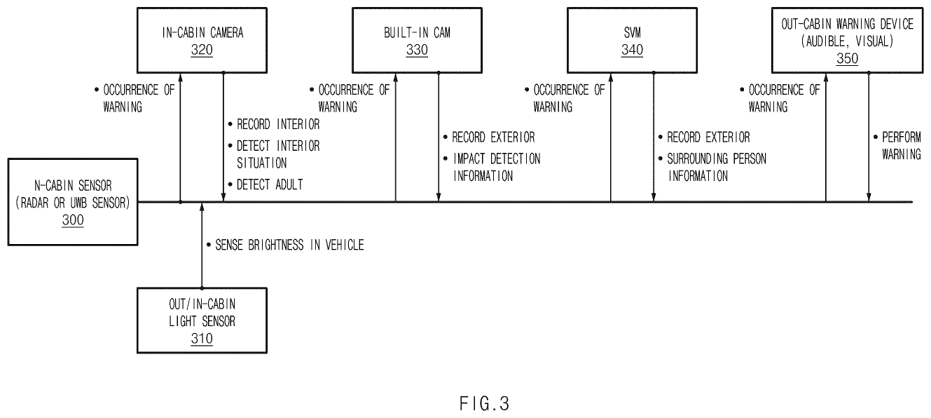

FIG. 3 shows an example of a system for performing a warning control function according to an example of the present disclosure.

Referring to FIG. 3, a vehicle control apparatus according to an example of the present disclosure is characterized by supporting a rear occupant alert (ROA). The ROA may be a function for monitoring a passenger state in a vehicle using an in-cabin sensor (e.g., radio and detection range (RADAR), an ultra-wideband (UWB) sensor, a camera, a pressure sensor, or the like) and providing a driver with a warning if necessary, which may detect minute motion (e.g., respiration, a heart rate, or subtle limb movement, etc.) in the vehicle via the RADAR to check whether there is a passenger. The UWB sensor may determine an accurate position of a passenger and whether there is the passenger via precise positioning. The UWB sensor is able to sense an accurate position of the passenger even in a state in which the passenger is hidden by an obstacle (e.g., a sheet, a blanket, a car seat, or a cargo bag, etc.) depending on its performance. The camera is able to check whether there is a passenger and a state of the passenger (e.g., whether the passenger is asleep, unconscious, or showing abnormal posture, etc.) using image recognition. As an example, the vehicle control apparatus according to an example of the present disclosure is able to capture and display a situation around the outside of the vehicle using the camera, measure a change in acceleration on 3 axes (X, Y, Z) using a G sensor (or an accelerometer), and then detect motion or a slop, if an impact occurs (e.g., a collision, jolt, or tilt from parking on uneven ground, etc.). Thus, the vehicle control apparatus is able to be combined with an unauthorized intrusion detection function via a built-in camera, a surround view monitor (SVM), or the like to detect motion which occurs in the vehicle and may be used as an anti-theft system (e.g., by capturing intrusion images, sounding alarms, or sending alerts to a user's smartphone, etc.). Furthermore, the vehicle control apparatus may analyze an operation pattern of a passenger via image analysis based on an AI technology and may then prevent an accident in which a child, an elderly or weak person, a pet, or the like is left unattended (e.g., by issuing alerts, unlocking doors, or activating cabin lights or ventilation, etc.).

As an example, if there occurs a difficulty in which the sensor, such as the RADAR or the UWB sensor, fails to discriminate between a water bottle, a metal body, or the like and a real body in a specific situation using radio waves, this may lead to a case in which an external warning occurs, although there is no passenger in the vehicle, as the ROA function operates as a false warning (e.g., misidentifying a thermos or foil-wrapped package as a human, etc.). Conservative tuning may be performed in the form of suppressing the false warning to control such a false warning. This may cause a trade-off phenomenon in which the performance of detecting a real infant is degraded (e.g., a sleeping child may go undetected to avoid false alerts, etc.). Table 1 below is to briefly describe an example associated with the false warning. As described in Table 1 below, after a specific ROA warning occurs, there may occur a case in which it is difficult to check the situation. This may lead to a problem in which response to real-time occurrence of the ROA warning is insufficient (e.g., lack of visual evidence or confirmation mechanism for the alert, etc.).

TABLE 1

| Phenomenon | Notes |
|---|---|
| Request to transmit and delete | The phenomenon is not specific |
| the rear seat passenger | and is unrelated to fast charging |
| notification text message after | and ROA. Although text message |
| fast charging | transmission occurs once per |
| | start-up, it continuously occurs. |
| | There is a need to additionally |
| | check the phenomenon when it |
| | occurs again. |
| There are no special issues when | The problem phenomenon does not |
| checking the current writing | occur again during lunch hours in |
| state or the like due to ROA | the service. |
| malfunction. It is good when | There is no function in which the |
| checking the operating condition | ROA specially operates, after 1 |
| by riding on the rear side. After | hour and 30 minutes, so there is |
| driving for about 1 hour and 30 | a need to additionally check the |
| minutes, the ROA warning sound | phenomenon when the phenomenon |
| occurs intermittently when the | occurs again. |
| door is locked. A text message | |
| alarm also comes to the connect | |
| side. After driving in the manner | |
| guided to the customer, it is | |
| good by checking the written | |
| condition. | |

Due to this, control of the ROA for the false warning is becoming a more important factor (e.g., to improve user trust, avoid unnecessary service visits, or ensure timely intervention in real emergencies, etc.). Thus, the vehicle control apparatus according to an example of the present disclosure proposes a method for fusing pieces of system information inside and outside a vehicle (e.g., in-cabin motion data, light sensor input, or external camera feeds, etc.) to reduce occurrence of a false warning. Particularly, the vehicle control apparatus proposes a method for transmitting an internal image and logging related data, if the ROA warning occurs, to more aggressively respond to the occurrence of the ROA warning (e.g., by storing timestamped camera footage and sensor logs, etc.). Furthermore, the vehicle control apparatus also proposes a method for efficiently controlling occurrence of a warning via external situation recognition, determining brightness in a vehicle to determine emergency, if the emergency occurs, and controlling an ambient light therefor (e.g., activating interior lights for clear camera capture in low light, etc.). As shown in FIG. 3, the vehicle control apparatus according to an example of the present disclosure may fuse a plurality of sensors inside and outside the vehicle and may determine and control a false warning. As an example, an in-cabin sensor, such as RADAR/UWB sensor, 300 may sense precise motion in the vehicle and may monitor a state of a driver using fine-grain operation (e.g., respiration rate tracking, body micromovement detection, etc.). Particularly, the RADAR/UWB sensor 300 may cooperate with a plurality of sensors in the vehicle to accurately analyze and provide motion and an action in the vehicle and may transmit the analyzed information to an out-cabin warning device 350 of the vehicle to automatize a risk warning (e.g., flashing hazard lights or sounding alerts if a passenger is detected, etc.). An out/in-cabin light sensor 310 may sense brightness in the vehicle and may also guide optimization of operation of an in-cabin camera 320 and a surround view monitor (SVM) 340 depending on a lighting condition. The out/in-cabin light sensor 310 may be linked to a built-in cam 330 to adjust image quality according to illumination and may cooperate with the in-cabin camera 320 to sense an accurate internal situation even in a low-illumination environment (e.g., during nighttime or when windows are tinted, etc.). The in-cabin camera 320 may monitor a situation/passenger in the vehicle, may detect a state of the driver (e.g., detect drowsy driving, distraction, or unresponsiveness, etc.), and may analyze an action of the passenger (e.g., movement patterns, seatbelt status, or posture, etc.). The in-cabin camera 320 may interwork with the RADAR/UWB sensor 300 to more precisely analyze an internal situation (e.g., detect minute motion, such as breathing or slight posture shifts, etc.), and may be linked to the out-cabin warning device 350 to provide a warning depending to the state of the driver (e.g., drowsiness, distraction, or unresponsiveness, etc.). The built-in cam 330 is able to record an external situation while driving and be used as evidence if an accident occurs. The built-in cam 330 may receive sensing data from the out/in-cabin light sensor 310 to optimize recording quality while driving at night and may cooperate with the SVM 340 to identify motion of a surrounding vehicle and support safety driving (e.g., lane departure monitoring or overtaking detection, etc.). The SVM 340 may be used to provide a 360-degree view around the vehicle, perform parking assist, and clear a blind spot. The SVM 340 may share data with the built-in cam 330 to record an important situation while driving and may fuse with the out-cabin warning device 350 to provide a warning about blind spot risk (e.g., blinking LEDs, vibrating seat, or automated voice alerts, etc.). The out-cabin warning device 350 may provide a driver and a surrounding vehicle with an audible or visual warning (e.g., a horn, an LED warning, a projected message, or the like) in a risk situation with regard to pieces of data collected and combined from the sensors. At this time, the out-cabin warning device 350 may be linked to the in-cabin camera 320 to provide an appropriate warning based on the state of the driver and may synthetically determine a surrounding situation using pieces of data of the SVM 340 and the built-in cam 330 (e.g., identifying approaching pedestrians, tailgating vehicles, or surrounding hazards, etc.).

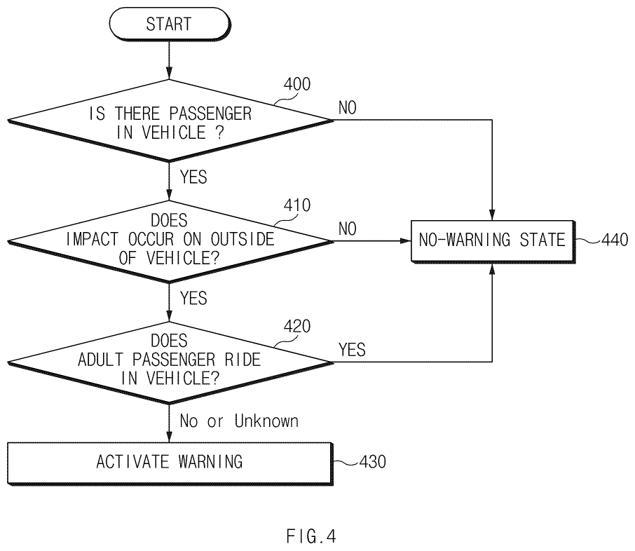

As described above, each sensor may share data with another sensor in real time to optimize safety and convenience of the vehicle, as well as performing an independent function. For example, a combination of the in-cabin camera 320 and the out-cabin warning device 350 may detect a drowsy state of the driver (e.g., nodding off, closed eyes, or head tilting, etc.) or the like to immediately provide a warning. A combination of the SVM 340 and the built-in cam 330 may be used generate incident records for accident prevention or forensic analysis (e.g., collision footage, lane departure events, or door impacts, etc.). The vehicle control apparatus according to an example of the present disclosure may more clearly determine occurrence of a false warning with regard to a combination of respective sensors and may transmit an internal image in real time, if a warning occurs, and may consider pieces of data of the plurality of sensors, if logging related data, thus reducing both the cause and frequency of false warnings to help create a smarter vehicle environment. Furthermore, the vehicle control apparatus according to an example of the present disclosure is able to recognize an external situation and may control brightness in the vehicle, thereby enhancing visibility and clarity of sensor data. The operation of fusing such respective sensors will be clearly described in FIGS. 4 to 7.

FIG. 4 shows an example of a method for controlling a false warning according to an example of the present disclosure.

Referring to FIG. 4, FIG. 4 is a flowchart for analyzing situations inside and outside a vehicle based on a determination process of various sensors and a rear occupant alert (ROA) of a vehicle control apparatus and providing a warning via the ROA according to an example of the present disclosure. In operation 400, a processor may detect whether there is a passenger in a vehicle via a RADAR/UWB sensor or an in-cabin camera (e.g., motion detection, posture tracking, etc.). This may include detecting motion in the vehicle or a biometric signal (e.g., a heartbeat or respiration, breathing, or subtle limb movement, etc.) to check whether there is a passenger. If it is determined that there is no passenger as a result of the checking, in operation 440, the processor may perform a no-warning operation. If it is determined that there is a passenger, in operation 410, the processor may determine whether an impact occurs on the outside of a vehicle with regard to a built-in cam (e.g., G-sensor, IMU, or impact detection trigger, etc.). At this time, the processor may detect whether an impact occurs on the outside of the vehicle during a parking state or while driving via an acceleration sensor in the built-in cam (or impact detection). If the impact occurs on the outside as a result of the detection, in operation 440, the processor may operate in a no-warning state.

On the other hand, if there is no impact on the outside, in operation 420, the processor may determine whether an adult passenger is present in the vehicle via an in-cabin camera. At this time, the processor may perform image analysis via the in-cabin camera (e.g., facial recognition, body size estimation, or posture classification, etc.). This is to detect whether there is an adult and determine the necessity of a safety system. If “No or unknown” is determined, this refers to no passenger or detection uncertainty (e.g., ambiguous detection). Thus, in operation 430, the processor may control activation of a warning. The occurrence of the warning according to an example of the present disclosure may include controlling an audible/visual warning device to be activated, if there is no passenger or the adult passenger is not detected when the impact occurs and then includes delivering a risk signal to a driver and an external environment (e.g., nearby persons or vehicles by flashing hazard lights, sounding a horn, or sending a mobile app alert, etc.). If the adult passenger is clearly detected, in operation 440, the processor may proceed to the no-warning state. If the impact occurs on the outside or the adult passenger is identified in the interior, the processor may proceed to the no-warning state, may control deactivation of a warning notification, and may control to record a current state.

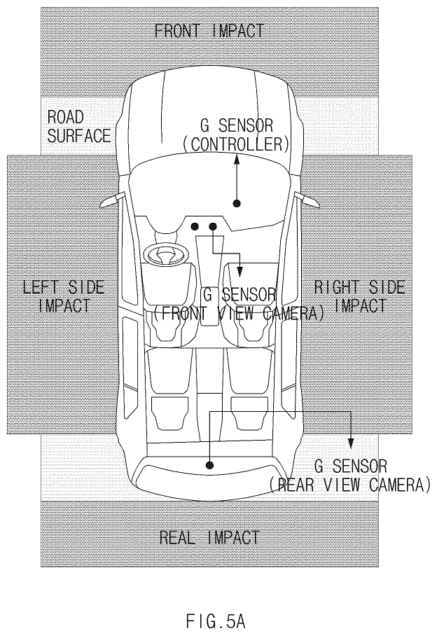

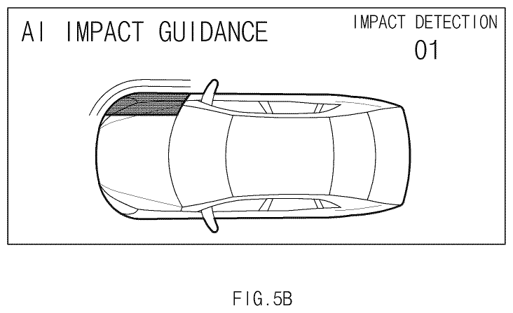

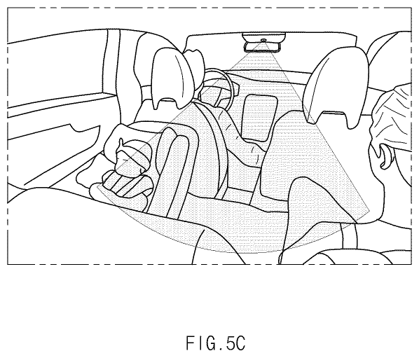

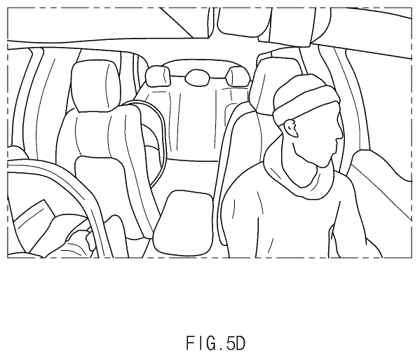

FIGS. 5A to 5D illustrate examples of performing fusion with system information inside and outside a vehicle, which is described in FIG. 4, and reducing a false warning. FIG. 5A illustrates checking an impact detection area using a G sensor for built-in cam impact detection. FIG. 5B is displaying the result of detecting impact occurrence using an AI technology. FIGS. 5C and 5D illustrate an example of detecting a presence of an adult via an in-cabin camera. FIGS. 5A to 5D according to an example of the present disclosure are shown for ease of description. Another example, including modification or expansion including the scope of the present disclosure for occurrence of the warning (e.g., alternative sensor arrangements, different alert thresholds, or multi-modal input variations, etc.) in the present disclosure, in which some steps are omitted may also belong to the category of the present disclosure.

As described using FIGS. 4 and 5A to 5C, a vehicle control apparatus for supporting an ROA system according to an example of the present disclosure may determine whether there is an external impact to control suppression of a warning notification immediately, if an accident occurs or an abnormal situation occurs while driving. For example, this includes identifying built-in cam data, and checking passenger information via an in-cabin camera to perform warning control in the form of immediately generating a warning notification, if there is no adult. This may switch to a warning or no-warning state for each situation directly connected with vehicle safety. Furthermore, warning control may be set with regard to sensitivity, user behavior patterns (e.g., habits, frequency of backseat usage, ride duration, or door-open history, etc.), and the like of the user for the warning. The present disclosure is to maintain security a parked state of the vehicle or safety inside/outside the vehicle and more clearly determine and provide a warning operation.

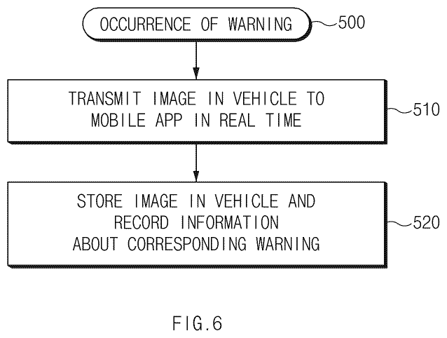

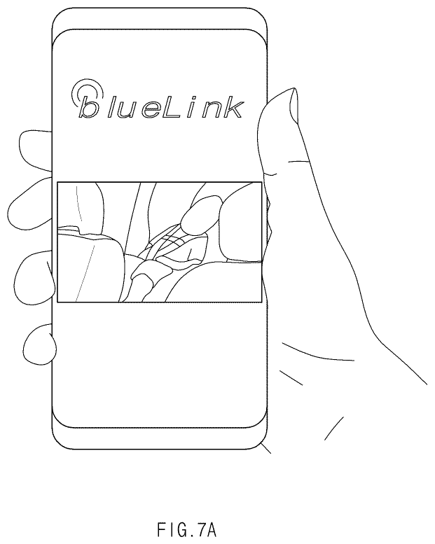

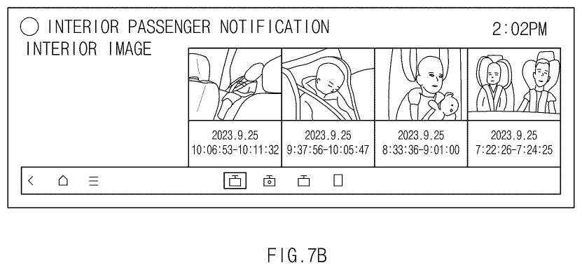

FIG. 6 shows an example of a method for controlling data logging, if a warning occurs, according to an example of the present disclosure. Furthermore, FIGS. 7A and 7B are drawings illustrating a vehicle interior image in various shapes according to an example of the present disclosure.

Referring to FIGS. 6, 7A, and 7B, FIGS. 6, 7A, and 7B are drawings illustrating data processing or storage flow if a warning occurs inside/outside a vehicle. A processor may control an in/out-cabin camera, a PADAR/UWB sensor, a built-in cam, and an out-cabin warning device to perform triggering and management of a warning via the in/out-cabin camera, the RADAR/UWB sensor, the built-in cam, and the out-cabin warning device. This may include that a warning occurs when an abnormal situation inside and outside a vehicle (e.g., intrusion, forced entry, an impact, or approach of an unauthorized adult to the vehicle, or loitering near the vehicle, etc.) is detected.

If a warning occurs in operation 500, in operation 510, the processor may control to transmit an image in the vehicle to a mobile app in real time (e.g., via LTE, 5G, Wi-Fi, or a V2X cloud-based interface, etc.). The processor may check an in-cabin camera and may control the in-cabin camera to capture a situation in the vehicle in real time and transmit data. At this time, the processor may control to use a network module to transmit image data to the mobile app (e.g., an external device or a mobile device running a mobile application, Wi-Fi, LTE/5G, or a cloud/specific V2X service). Thus, the processor may enable a vehicle owner to monitor a situation inside/outside the vehicle in real time and take necessary action. For example, a live image from the vehicle may be transmitted to the mobile app in real time as shown in FIG. 7A.

In operation 520, the processor may control to store an image captured in the vehicle and record information about a corresponding warning. As an example, the processor may control to store in the image in the vehicle in the form of a built-in cam. Date and time information at a time point when such a warning occurs may be used as logging data associated with the occurrence of the warning (e.g., for later retrieval, crash analysis, or system audit, etc.). Furthermore, it is possible to display the image in the vehicle in the same shape as FIG. 7B. As described above, the processor may control an in-cabin camera to continuously capture image data via the in-cabin camera or may control an internal storage device to store an image and warning-related data via the internal storage device (or a built-in cam function) (e.g., SD card, NAND flash, or built-in memory, etc.). This is usable as evidence for the warning that occurred or may be used as analysis data for a situation after an accident and data for solving a vehicle security problem. A vehicle control apparatus according to an example of the present disclosure may reinforce vehicle security and user experience via real-time monitoring, data storage, or harmony between warning systems (e.g., synchronizing alerts between sensors and optimizing UI notifications, etc.). As an example, the vehicle control apparatus is able to assist in reinforcing an intrusion detection function (e.g., generating a warning, if the in-cabin camera detects an unauthorized passenger, and transmitting an image to a mobile app of an owner in real time, sending real-time alerts to the mobile app when a stranger is detected in the cabin, or flashing the hazard lights, etc.), reinforcing an impact detection function (e.g., recording a situation in the vehicle, if the built-in cam detects an external impact, and accurately logging an accident time point to use it as insurance processing and legal evidence, capturing high-resolution video during a fender bender, timestamping the event, and saving data for legal reporting, etc.), or reinforcing an unauthorized access function (e.g., activating a warning, if the RADAR/UWB sensor senses suspicious motion, and allowing the vehicle owner to monitor a situation in real time, sounding an alarm and activating in-cabin lights if a door is opened without a key, etc.).

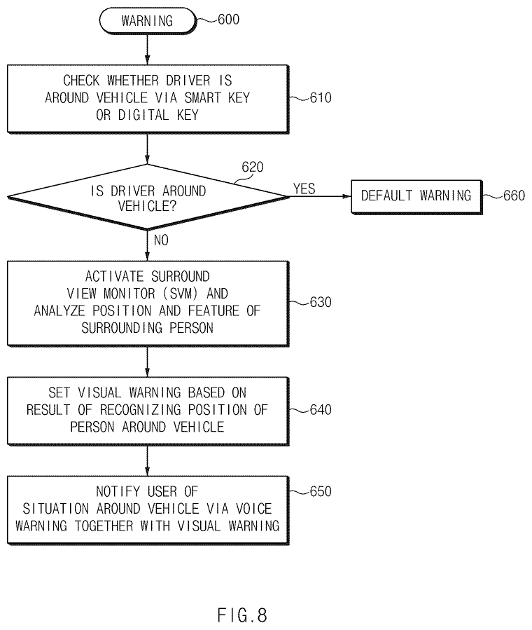

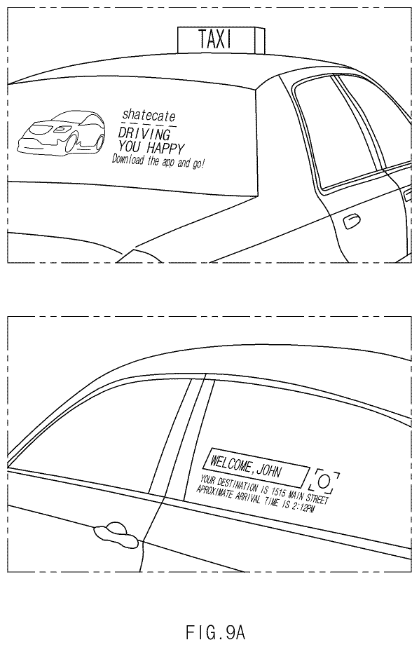

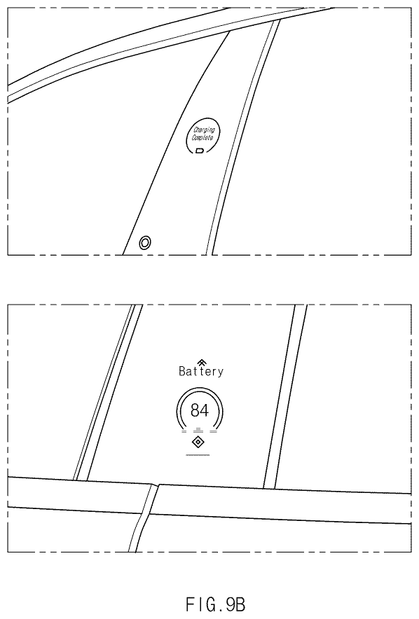

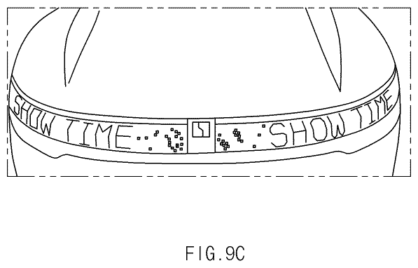

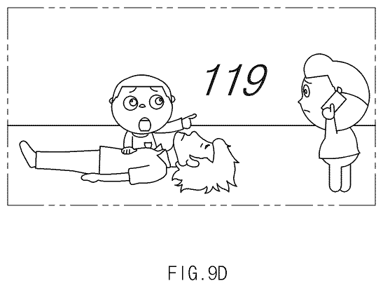

FIG. 8 shows an example of a method for recognizing an external situation and controlling a warning according to an example of the present disclosure. In this regard, FIGS. 9A to 9D show examples of performing a warning based on sensor fusion, environment lighting, or driver/passenger state according to an example of the present disclosure.

Referring to FIG. 8, FIG. 8 is a drawing illustrating flow for recognizing a situation around and inside a vehicle to generate a warning and controlling the warning depending on the situation. In operation 600, a processor may additionally check a driver and an external environment, if a warning occurs. This is to check whether an abnormal situation associated with vehicle security and safety occurs. In operation 610, the processor may check whether the driver is around a vehicle via a smart key or a digital key. At least one of a smart key, a digital key, a smart key proximity sensor, Bluetooth® Low Energy (BLE), an NFC communication module, or a UWB communication module (e.g., Apple® UI chip, Samsung® UWB key, etc.) is able to check whether the driver is around the vehicle. At this time, if it is determined that the driver is around the vehicle (620—YES), in operation 660, the processor may proceed to a default warning operation. A default warning may be a state in which a warning level is set to be low, which may include a visual and voice warning depending on a setting of a user. Furthermore, if the driver is around the vehicle, the processor may provide a warning in a simplified form without separate analysis.

If it is determined that there is no driver (620—NO), in operation 630, the processor may activate a surround view monitor (SVM) and may analyze a position and a feature of a surrounding person (e.g., proximity to vehicle, number of individuals, or movement direction). The processor may identify a position and a feature (e.g., a color of clothes) of an external person via the SVM or a built-in cam and an image analysis system (e.g., computer vision, object tracking, or pattern recognition). This may include analyzing the position and feature (e.g., a color of clothes, size of silhouette, walking speed, or movement pattern, etc.) of a person around the vehicle to ensure that visual information is accurate and contextual. In operation 640, the processor may set a visual warning based on the result of recognizing the position of the person around the vehicle (e.g., display intensity, flashing rate, or directional guidance). At this time, the processor may differently set a warning indication depending on a situation around the vehicle. As an example, if a person closely approaches the vehicle, the processor may set to provide a strong visual warning (e.g., flashing LEDs, windshield projection, or headlight strobe pattern). To this end, the processor may control an in/out-cabin display, as well as an LED warning lamp, to issue visual alert. Furthermore, in operation 650, the processor may notify the user of the situation around the vehicle via a voice warning together with the visual warning. This may include transmitting a warning message using a voice inside or outside the vehicle. To this end, a vehicle warning system (e.g., a speaker, a synthesized voice assistant, or a notification voice) is usable.

FIG. 9A is a drawing for providing a warning to the front, the side, and the rear via a window display according to the present example. FIG. 9B is a drawing for providing a warning to the side via a filler display according to the present example. FIG. 9C is a drawing for providing a warning to the front and the rear via an LED display according to the present example. FIG. 9D is a drawing illustrating an example of pointing out a specific person via a voice warning according to the present example. As described above, the vehicle control apparatus according to the present example may provide a customized warning system for reinforcing the vehicle security and being optimized for the driver and the surrounding situation, which may determine whether there is a driver around the vehicle using the smart key or the digital key, may allow the surround view monitor (SVM) and the image analysis system to check the position and the feature of the surrounding person, if there is no driver, and deliver information suitable for the situation via the visual and voice warnings (e.g., flashing LED indicators, spoken phrases like “Please step away from the vehicle,” etc.) to prevent an accident and maintain safety.

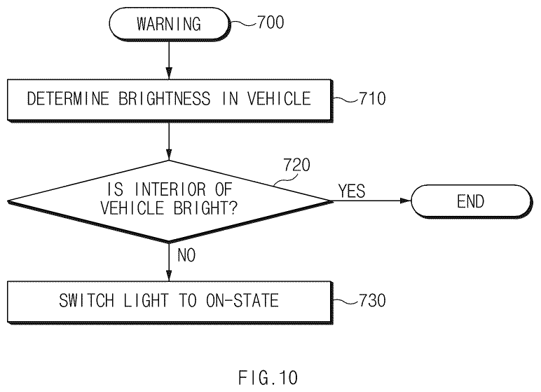

FIG. 10 shows an example of a method for controlling an ambient light with regard to brightness in a vehicle according to an example of the present disclosure.

Referring to FIG. 10, FIG. 10 is a drawing illustrating a flow for determining illumination in a vehicle, if a warning occurs, and controlling an ambient light in the vehicle based on the determined illumination level. If a warning occurs as a specific situation occurs inside/outside the vehicle, in operation 710, a processor may check an in-cabin light sensor and may collect internal illumination data to determine brightness in the vehicle (e.g., cabin lighting levels during nighttime parking, tunnel entry, or in underground garages, etc.). Furthermore, the processor may measure the brightness state inside and outside the vehicle using the in-cabin light sensor and an out-cabin light sensor. Herein, an internal illumination value is usable to control an ambient light in the vehicle (e.g., footwell lighting, dashboard glow, or reading lamps, etc.) and an external illumination value is usable to adjust brightness of a vehicle display (e.g., a head-up display, a central infotainment screen, or a digital instrument cluster, etc.) and a strength of a warning notification. As an example, in operation 720, the processor may check whether the interior of the vehicle is bright or dark via the in-cabin light sensor. If the interior of the vehicle is sufficiently bright as a result of the determination (YES), because there is no need for an additional light, the processor may end the process. On the other hand, if it is determined that the interior is dark (NO), in operation 730, the processor may proceed to switching a light to an on-state (e.g., enabling dome lights, ambient LED strips, or door pocket lights, etc.). At this time, the processor may control an ambient light control device (e.g., an LED or an electronic control unit, a PWM-controlled LED driver, a zoned interior lighting controller, or a smart lighting ECU, etc.) and may perform control to turn on the ambient light such that a passenger is able to see the interior of the vehicle. Furthermore, the processor may adjust a display, using an external illumination value. The processor may adjust brightness of a vehicle display (e.g., a dashboard, a head-up display, center touchscreen, rearview mirror display, or driver assistance UI, etc.) depending on the external illumination value of the vehicle to adjust brightness such that a driver is able to visually conveniently check information. Furthermore, the processor may provide a stronger visual warning (e.g., increase brightness of an LED warning lamp, increase LED strobe rate, pulse frequency, or brightness of hazard indicators, etc.), if the outside is dark, to adjust strength of a warning notification. Furthermore, the processor may control to reduce display brightness in the daytime (or a bright external environment) (e.g., during clear weather or in direct sunlight, etc.) and maintain the warning notification as a default setting and may control to increase the display brightness at night (or in a dark external environment) (e.g., when parked in an unlit alley, garage, or roadside, etc.) and increase strength and frequency of the warning notification. As described above, the vehicle control apparatus according to an example of the present disclosure may automatically control the light to ensure clearer image data in monitoring the environment in the vehicle in real time and may then ensure convenience of the user and enhanced safety of the vehicle.

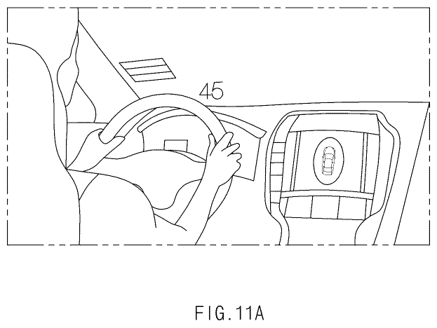

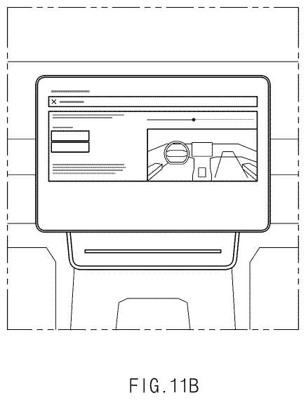

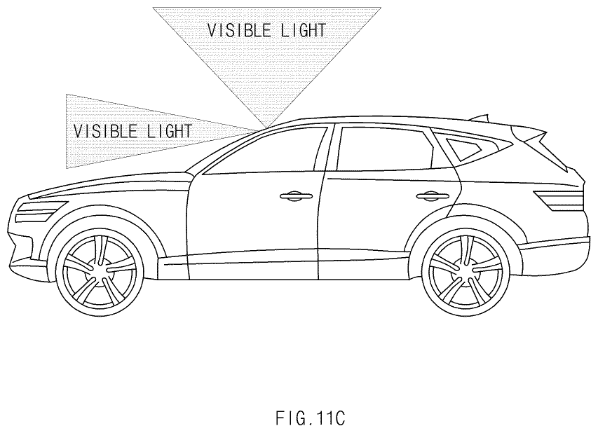

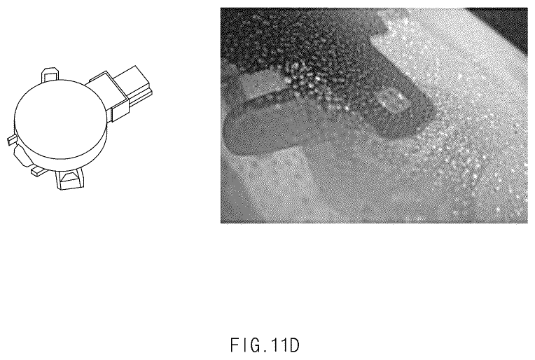

FIG. 11A, FIG. 11B, FIG. 11C, and FIG. 11D show an example of controlling an ambient light with regard to brightness in a vehicle according to an example of the present disclosure.

FIG. 11A and FIG. 11B are an example of controlling a vehicle display using a light sensor value for interior in the vehicle display according to an example of the present disclosure. FIG. 11C and FIG. 11D are an example of controlling a vehicle display using a vehicle integrated rain sensor and a light sensor value for exterior conditions according to an example of the present disclosure.

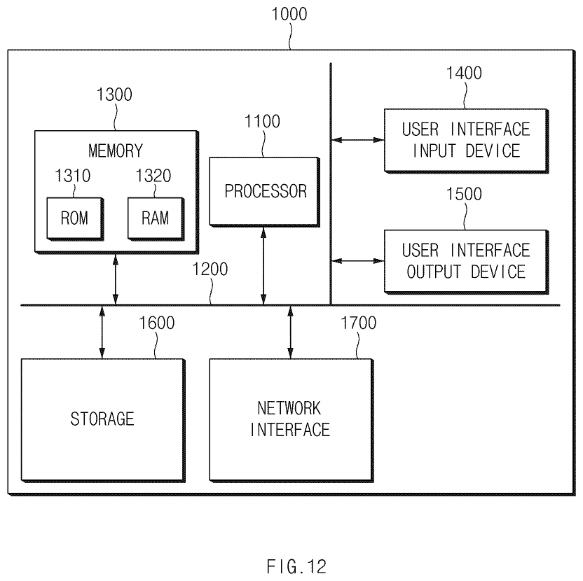

FIG. 12 shows an example computing system according to an example of the present disclosure.

Referring to FIG. 12, a computing system 1000 may include at least one processor 1100, a memory 1300, a user interface input device 1400, a user interface output device 1500, storage 1600, and a network interface 1700, which are connected with each other via a bus 1200. For example, the user interface input device 1400 may include a touchpad, a keyboard, a microphone, or a steering wheel-mounted button, etc., and the user interface output device 1500 may include a speaker, a display panel, a head-up display, or a haptic actuator, etc.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320. For example, the storage 1600 may include a solid-state drive (SSD), a hard disk drive (HDD), a secure digital (SD) card, or an embedded multimedia card (eMMC), etc.

Accordingly, the operations of the method or algorithm described in connection with the examples disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a RAM, a flash memory, a ROM, an EPROM, an EEPROM, a register, a hard disc, a removable disk, and a CD-ROM. Additional examples of the storage medium may include a digital versatile disc (DVD), a Blu-ray disc, or a network-attached storage (NAS) device, etc.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components. For example, the user terminal may include a vehicle-mounted control unit, a smart infotainment system, or a telematics control unit, etc.

An example of the present disclosure provides a vehicle control apparatus for determining occurrence of a warning with regard to information of at least one sensor which is supported and a method thereof.

Another example of the present disclosure provides a vehicle control apparatus for controlling occurrence of a warning with regard to situations inside and outside a vehicle and a method thereof.

Another example of the present disclosure provides a vehicle control apparatus for obtaining and collecting image data for occurrence of a warning and a method thereof.

Another example of the present disclosure provides a vehicle control apparatus for sharing image data for occurrence of a warning in real time and a method thereof.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, a vehicle control apparatus may include a processor that checks at least one of a plurality of sensors provided in a vehicle, determines occurrence of a warning with regard to information of the checked sensor, logs an image in the vehicle with regard to the occurrence of the warning to transmit the image in real time, and controls to variably change a warning setting with regard to an external environment of the vehicle, the processor supporting a rear occupant alert (ROA), and at least one sensor that performs an operation under control of the processor.

A warning setting may refer to configurable parameters of a warning signal that may be adjusted based on contextual information. For example, when a driver is detected near the vehicle, a default warning setting may be applied with reduced intensity to avoid unnecessary alerts. A visual form of the warning signal may also be adjusted based on the presence and proximity of a person near the vehicle, as determined by sensors. Additionally, a brightness of internal or external lights of the vehicle may be controlled based on data from in-cabin or out-cabin light sensors. These illumination-based settings may ensure that a warning signal, whether visual or auditory, remain perceivable under varying external conditions, such as daylight or nighttime environments. Overall, the warning setting may encompass parameters like warning level, output mode, timing, and signal strength, which are intelligently controlled to enhance safety and reduce false alarms.

In an example, the processor may detect whether there is a passenger in the vehicle via the at least one sensor. The at least one sensor may be provided in the vehicle and may include at least one of radio and detection ranging (PADAR), an ultra-wideband (UWB) sensor, or an in-cabin camera.

In an example, the processor may determine whether an impact occurs on the outside of the vehicle via the at least one sensor, if it is determined that there is the passenger in the vehicle. The at least one sensor may be provided in the vehicle and may include at least one of a built-in cam or an acceleration sensor.

In an example, the processor may detect whether the passenger in the vehicle is an adult via the at least one sensor and may analyze an image checked via the at least one sensor to control the occurrence of the warning. The at least one sensor may include the in-cabin camera provided in the vehicle.

In an example, the processor may control a warning device to be activated and may generate a warning, if it is determined that there is no passenger in the vehicle or that an adult passenger does not ride in the vehicle when the impact occurs on the outside of the vehicle, or may control the warning device to be deactivated and may fail to generate the warning, if it is determined that the adult passenger rides in the vehicle when the impact occurs on the outside of the vehicle.

In an example, the processor may control to transmit image data in the vehicle to a mobile app in real time via the at least one sensor. The at least one sensor may include a network module and may include at least one of a wireless-fidelity (Wi-Fi) module or a mobile communication module.

In an example, the processor may control to store the image data in the vehicle via the at least one sensor and record information about the occurrence of the warning. The at least one sensor may include the built-in cam.

In an example, the processor may check the interior and exterior of the vehicle via the at least one sensor and control the occurrence of the warning, the at least one sensor including at least one of a smart key, a digital key, a smart key proximity sensor, Bluetooth low energy (BLE), a near field communication (NFC) communication module, or a UWB communication module, and may check whether there is a driver of the vehicle around the vehicle via the at least one sensor.

In an example, the processor may set a warning device to a default warning to set a warning level to be low, if checking that there is the driver of the vehicle around the vehicle.

In an example, the processor may check the interior and the exterior of the vehicle, may set a visual warning based on the result of recognizing a position of a person around the vehicle, and may control to differently set warning indication via the at least one sensor with regard to a situation around the vehicle. The at least one sensor may include at least one of an in/out-cabin display, a light-emitting diode (LED) warning lamp, or a vehicle warning system.

In an example, the processor may check illumination inside and outside the vehicle and may control lights inside and outside the vehicle via the at least one sensor based on the determined illumination information. The at least one sensor may include at least one of an in-cabin light sensor, a vehicle display, or an LED warning lamp. The vehicle display may include at least one of a dashboard or a head-up display.

According to another example of the present disclosure, a vehicle control method may include checking at least one sensor among a plurality of sensors provided in a vehicle, determining occurrence of a warning with regard to information of the checked sensor, logging an image in the vehicle with regard to the occurrence of the warning to transmit the image in real time, and controlling to variably change a warning setting with regard to an external environment of the vehicle.

In an example, the vehicle control method may further include detecting whether there is a passenger in the vehicle.

In an example, the vehicle control method may further include determining whether an impact occurs on the outside of the vehicle, if it is determined that there is the passenger in the vehicle.

In an example, the vehicle control method may further include detecting whether the passenger in the vehicle is an adult, analyzing the image with regard to the information of the checked sensor, and controlling the occurrence of the warning with regard to the analysis.

In an example, the vehicle control method may further include activating the occurrence of the warning, if there is no passenger in the vehicle or an adult passenger is not detected when the impact occurs on the outside of the vehicle or deactivating the occurrence of the warning, if the adult passenger is detected when the impact occurs on the outside of the vehicle.

In an example, the vehicle control method may further include transmitting data for the image to a mobile app in real time and storing the data for the image and recording information about the occurrence of the warning.

In an example, the vehicle control method may further include checking whether there is a driver of the vehicle around the vehicle and setting the occurrence of the warning to a default warning to set a warning level to be low, if there is the driver of the vehicle around the vehicle.

In an example, the vehicle control method may further include checking the interior and exterior of the vehicle and setting a visual warning based on the result of recognizing a position of a person around the vehicle. The setting of the visual warning may include differently setting warning indication with regard to a situation around the vehicle.

In an example, the vehicle control method may further include checking illumination inside and outside the vehicle and controlling lights inside and outside the vehicle based on the checked illumination information. The controlling of the lights may include controlling at least one of an in-cabin light sensor, a vehicle display, or an LED warning lamp.

The present technology may provide a warning system which reinforces vehicle security and is optimized for a driver and a surrounding situation. Such a present technology may fuse pieces of information of a plurality of sensors to support reliable determination of the occurrence of a warning, may perform real-time monitoring, and may share logging data to reinforce vehicle security and user experience with the user. Furthermore, the present technology may provide a different visual/voice warning with regard to a situation inside/outside the vehicle to more smoothly propose a warning for an accident via the occurrence of the warning suitable for the situation and may then provide a safe vehicle environment.

Furthermore, the present technology may automatically control a light to ensure more clear image data in monitoring an environment inside/outside the vehicle in real time and may then provide convenience of the user and safety reinforcement of the vehicle.

In addition, various effects ascertained directly or indirectly through the present disclosure may be provided.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

Therefore, examples of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. An apparatus for a vehicle, the apparatus comprising:
a processor; and
a memory storing at least one instruction that, when executed by the processor communicating with the memory, is configured to cause the apparatus to:
activate at least one sensor of a plurality of sensors of the vehicle,
determine, based on the sensing data of the at least one activated sensor, that a warning condition associated with the vehicle is satisfied,
generate image data associated with the warning condition and transmit, to a node, the image data in real time, wherein the image data corresponds to an interior image of the vehicle,
adjust, based on a detected external environment of the vehicle, at least one configurable parameter associated with a warning signal indicating the warning condition, and
output, based on the warning condition being satisfied and the at least one adjusted configurable parameter, the warning signal.

2. The apparatus of claim 1, wherein the at least one instruction, when executed by the processor communicating with the memory, is configured to cause the apparatus to determine that the warning condition is satisfied by:
determining, based on the sensing data, whether a potential occupant is present in the vehicle, and
wherein the at least one sensor comprises at least one of radio and detection ranging (RADAR), or an ultra-wideband (UWB) sensor.

3. The apparatus of claim 2, wherein the at least one instruction, when executed by the processor communicating with the memory, is configured to cause the apparatus to detect the external environment by:
determining, via at least one second sensor of the plurality of sensors and based on a determination that the potential occupant is present in the vehicle, whether an impact occurs on an exterior of the vehicle, and
wherein the at least one second sensor comprises at least one of a built-in camera or an acceleration sensor.

4. The apparatus of claim 3, wherein the at least one instruction, when executed by the processor communicating with the memory, is configured to cause the apparatus to:
determine, via the at least one sensor and based on the image data, whether the potential occupant is an adult passenger, and
process the interior image to verify the warning condition, wherein the interior image is captured by at least one third sensor of the plurality of sensors, and
wherein the at least one third sensor comprises an in-cabin camera.

5. The apparatus of claim 4, wherein the at least one instruction, when executed by the processor communicating with the memory, is configured to cause the apparatus to:
activate a warning device to output the warning signal based on:
no passenger being present in the vehicle, or
no adult passenger being present in the vehicle and the impact occurring on the exterior of the vehicle; or
control, based on the adult passenger being present in the vehicle and the impact occurring on the exterior of the vehicle, the warning device to remain deactivated such that a warning signal is suppressed.

6. The apparatus of claim 4, wherein the at least one instruction, when executed by the processor communicating with the memory, is configured to cause the apparatus to transmit the image data by:
transmitting, via a wireless communication circuit, the image data to a mobile device in real time, and
wherein the wireless communication circuit comprises at least one of a wireless-fidelity (Wi-Fi) transceiver or a mobile communication transceiver.

7. The apparatus of claim 6, wherein the at least one instruction, when executed by the processor communicating with the memory, is configured to cause the apparatus to:
record information about the warning condition.

8. The apparatus of claim 1, wherein the at least one instruction, when executed by the processor communicating with the memory, is configured to cause the apparatus to:
identify, via the at least one sensor, a plurality of types of sensing data associated with an interior and an exterior of the vehicle, and
determine, based on the plurality of types of sensing data, whether the warning condition is satisfied, wherein the at least one sensor comprises a vehicle key proximity sensor, a Bluetooth low energy (BLE) circuit, a near field communication (NFC) circuit, or a ultra-wideband (UWB) communication circuit; and
determine, via the at least one sensor, whether a driver of the vehicle is present within a threshold distance from the vehicle.

9. The apparatus of claim 8, wherein the at least one instruction, when executed by the processor communicating with the memory, is configured to cause the apparatus to:
adjust, based on the driver being present within the threshold distance from the vehicle, operation of a warning device to output a warning signal having a reduced intensity level.

10. The apparatus of claim 9, wherein the at least one instruction, when executed by the processor communicating with the memory, is configured to cause the apparatus to:
based on the plurality of types of sensing data and a position of a person within a threshold distance from the vehicle, set a visual warning, and
adjust a warning signal setting based on second sensing data obtained from at least one sensor of the plurality of sensors, wherein the second sensing data indicates a state associated with the vehicle, and
wherein the warning device comprises at least one of an in/out-cabin display, a light-emitting diode (LED) warning lamp, or a speaker.

11. The apparatus of claim 8, wherein the at least one instruction, when executed by the processor communicating with the memory, is configured to cause the apparatus to:
determine, via at least one light sensor of the plurality of sensors, cabin illuminance inside the vehicle and exterior illuminance outside the vehicle, and
control, based on the cabin illuminance and the exterior illuminance, lights inside and outside the vehicle,
wherein the at least one light sensor comprises at least one of an in-cabin light sensor or an out-cabin light sensor,
wherein the apparatus further comprises at least one of a vehicle display or an LED warning lamp for outputting a visual warning, and
wherein the vehicle display comprises at least one of a dashboard or a head-up display.

12. A method performed by an apparatus for a vehicle, the apparatus comprising:
activating at least one sensor of a plurality of sensors of the vehicle;
determining, based on sensing data of the activated at least one sensor, that a warning condition associated with the vehicle is satisfied;
generating image data associated with the warning condition;
transmitting, to a node, the image data in real time, wherein the image data corresponds to an interior image of the vehicle;
adjusting, based on a detected external environment of the vehicle, at least one configurable parameter associated with a warning signal indicating the warning condition; and
outputting, based on the warning condition being satisfied and the at least one adjusted configurable parameter, the warning signal.

13. The method of claim 12, further comprising:
determining, based on the sensing data, whether a potential occupant is present in the vehicle,
wherein the at least one sensor comprises at least one of radio and detection ranging (RADAR) or an ultra-wideband (UWB) sensor.

14. The method of claim 13, further comprising:
determining, via at least one second sensor of the plurality of sensors and based on a determination that the potential occupant is present in the vehicle, whether an impact occurs on an exterior of the vehicle,
wherein the at least one second sensor comprises at least one of a built-in camera or an acceleration sensor.

15. The method of claim 14, further comprising:
determining, via the at least one sensor and based on the image data, whether the potential occupant is an adult passenger;
processing the interior image to verify the warning condition, wherein the interior image is captured by at least one third sensor of the plurality of sensors; and
determining, based on the processed image, that the warning condition is verified.

16. The method of claim 15, further comprising:
generating the warning signal, based on:
no passenger being present in the vehicle, or
no adult passenger being detected and the impact occurring on the exterior of the vehicle; or
suppressing the generation of the warning signal, based on the adult passenger being detected in the vehicle and the impact occurring on the exterior of the vehicle.

17. A vehicle comprising:
a plurality of sensors comprising at least one first sensor configured to monitor an interior of the vehicle and at least one second sensor configured to monitor an exterior of the vehicle;
a processor; and
a memory storing at least one instruction that, when executed by the processor communicating with the memory, is configured to cause the vehicle to:
control the at least one first sensor to monitor the interior of the vehicle,
detect, based on the first sensor data associated with the interior of the vehicle, a potential occupant inside the vehicle,
control the at least one second sensor to monitor the exterior of the vehicle,
determine, based on the second sensor data associated with the exterior of the vehicle, an external condition of the vehicle,
based on information associated with the detected potential occupant and the external condition, determine whether to generate a warning signal,
adjust, based on the external condition of the vehicle, at least one of a visual or auditory form of the warning signal such that at least one of the potential occupant or the warning signal is perceivable under the external condition of the vehicle,
store information associated with the warning signal, wherein the information associated with the warning signal comprises image data and timing information, and
transmit the image data in real time to a remote device.

18. The vehicle of claim 17, wherein the at least one instruction, when executed by the processor communicating with the memory, is configured to cause the vehicle to:
activate outputting of the warning signal based on:
no adult passenger being detected inside the vehicle, and
an external impact being detected, and
suppress outputting of the warning signal based on an adult passenger being detected inside the vehicle and the external impact being detected.

19. The vehicle of claim 17, wherein the at least one instruction, when executed by the processor communicating with the memory, is configured to cause the vehicle to tag the image data with a timestamp identifying when the warning signal was generated, and
control, based on a detected illumination level of the vehicle, lighting of the vehicle such that the visual form of the warning signal and visual display of images associated with the image data remain visible even under illumination levels of the vehicle below a threshold.

20. The vehicle of claim 19, wherein the at least one instruction, when executed by the processor communicating with the memory, is configured to cause the vehicle to increase, based on the detected illumination level, brightness of at least one of an interior lighting of the vehicle or an exterior lighting of the vehicle.
